(19) United States
(12) Patent Application Publication
(10) Pub. No.: US 2005/0020257 A1
(43) Pub. Date: Jan. 27, 2005

(54) Communications interface device

(76) Inventor: Michael Davis, Sherman Oaks, CA (US)

Correspondence Address: Colin P. Abrahams, Suite 400, 5850 Canoga Avenue, Woodland Hills, CA, 91367, US

(21) Appl. No.: 10/768,969

(22) Filed: Jan. 30, 2004

Related U.S. Application Data
(63) Continuation of application No. 09/973,233, filed on Oct. 9, 2001.
(60) Provisional application No. 60/266,992, filed on Feb. 7, 2001.

(51) Int. Cl. H04M 1/00

(52) U.S. Cl. 455/426.1

(57) ABSTRACT

A communications interface device for transferring signals between a Computer and telephone comprises a housing and a processor accommodated by the housing for processing signals received from the Computer and the telephone. A first connection port in or on the housing connects to the Computer so that signals can be transmitted between the first connection port and the Computer, the first connection port also being connected to the processor. A second connection port in or on the housing connects to a telephone so that signals can be transmitted between the second connection port and the telephone, the second connection port also being connected to the processor.

### CROSS REFERENCE TO RELATED APPLICATIONS

This application is a continuation of U.S. patent application Ser. No. 09/973,233 filed Oct. 9, 2001, which claims the benefit of U.S. Provisional Application No. 60/266,992 filed Feb. 7, 2001. Both of these applications are incorporated herein in their entirety.

### FIELD AND BACKGROUND OF THE INVENTION

The invention relates, in one aspect, to an interface device that allows many different types of computers, including but not limited to most notebook computers, palm and palmtop computers and Personal Digital Assistants (“PDA”), which may be using many different operating systems, (all of the above referred to collectively in this specification as (“Computers”), to communicate with almost any telephone (land or wireless), worldwide. In this specification, “telephone”, unless otherwise indicated, includes a land based or wireless telephone.

Currently, there is no easy method and/or device to connect Computers to telephone systems (whether wired or wireless), except for a traditional single line, landline telephone with a normal RJ-11 telephone connector.

Over 100 million Computers and PDAs have already been sold and millions more are now being made and sold with the ability to access the Internet, the limiting factor is that they all require a single line, landline telephone (no business or hotel multi-line telephone systems) and no pay phone, with a hard wired RJ-11 connector. To date, there does not appear to be any device which is able to connect these Computers to landline telephones without a hardwired telephone connection and a hardwired computer connection. There is, therefore, a need for a communications interface device which has such a function. This can be achieved, in one embodiment, by using a modem with an acoustic coupler to connect a telephone and an infrared transceiver to connect to a Computer.

Modems have been known for some time, as are known acoustic couplers and infrared transceivers. However, the invention is unique in the concept and application in which these three components are packaged together as a freestanding integrated device, wherein the integrated device uses advantageously the function of each component so as to create a relationship between them which operates in an inventive and unique manner.

To the best of Applicant's knowledge, there is no existing availability of a device using an acoustic coupler as a telephone interface and an infrared transceiver as a Computer interface housed in one unit to all allow Computers to communicate with landline telephones. There is also apparently no presently available device for the concept of a device using a cellular telephone holder with an electrical interface and an infrared transceiver as a Computer interface (either with or without a modem) housed in one unit, or configured together in some form to provide an interface, to all allow Computers to communicate with mobile telephones.

Another aspect of the invention is to provide a device for carrying out the method and concept of holding a mobile/cellular/PCS telephone so the antenna is still and vertical for better radio reception, and providing the communications interface ability of the present invention.

In the present state of the art, the only way to connect a cell or any other type of mobile phone to a computer would be to use one of the following arrangements:

1. Special cellular serial cable; a special Internet ready cellular phone; a cellular carrier with Internet capabilities; and, usually paying the cellular carrier an additional fee per month.

2. PCMCIA or Compact Flash special cellular modem with cable to specific phone; a cellular carrier with Internet capabilities; and, paying the cellular carrier an additional fee per month.

3. Cell phone with a proprietary infrared modem. Access is limited to GSM cellular only.

Previously, the only way to connect a Computer to a land phone where there was no hardwire connection available was with a computer with a modem. and an outboard acoustic coupler with the right software.

### SUMMARY OF THE INVENTION

According to one aspect of the invention, there is provided a communications interface device for transferring signals between a Computer and telephone, the interface device comprising: a housing; processing means accommodated by the housing for processing signals received from the Computer and the telephone; first connecting means in or on the housing connectable to the Computer so that signals can be transmitted between the first connecting means and the Computer, the first connecting means also being connected to the processing means; and a second connecting means in or on the housing connectable to a telephone so that signals can be transmitted between the second connecting means and the telephone, the second connecting means also being connected to the processing means.

According to another aspect of the invention, there is provided a communications interface device comprising: a casing comprising a base portion and a lid hinged thereto, the lid being movable between an open and closed position with respect to the base portion, the casing defining a chamber; a microphone located within the chamber; a speaker located within the chamber; means for varying the distance between the microphone and the speaker; a power source; at least one connection port to facilitate communication between the interface device and a Computer; and a modem connected to the microphone and/or speaker as well as the connection port.

The present invention is therefore for a communication interface device which facilitates data transmission between Computers and telephones. The present invention provides, in one aspect, easier Computer access to the Internet from both land telephones and cellular/PCS telephones.

One advantage of the communication interface device of the invention is to provide a cableless and wireless Internet and other telephone connections to many brands and operating systems of Computers from many kinds of telephone systems, hardwired and mobile, to send and receive data worldwide through a wireless connection.

One aspect of the communication interface device of the invention is to enable many different types and operating systems of Computers and to access multi-line digital land telephone systems. Yet a further aspect of the communication interface device of the invention is to enable many different types and operating systems of Computers and to access most cellular/PCS and other wireless telephone systems.

In one embodiment of the invention for mobile telephones, a communications interface device has a modem, an infra red (IR) transceiver and a mobile telephone holder with an electrical and/or acoustic connector. One embodiment of the communication interface device of the invention for an application for landline telephones is a device that has a modem, an IR transceiver and an acoustic connector.

The many uses that can be derived by establishing an effective and simple connection between Computers and telephones include, but are not limited to, the bi-directional transfer of data such as email, faxes, files, graphics, web information, and the like. With the ever widening use of both telephones (especially wireless telephone systems), and Computers of different sizes and complexities, the ability to present a universal device to permit communication between these various devices becomes increasingly desirable and necessary.

The communication interface device of the invention preferably connects to Computers primarily through an infra red communication. However, the invention is not limited to IR communication, and can also communicate through any other appropriate connections, such as (but not limited to) serial, parallel, USB, RJ-11 or other ports.

The communication interface device of the invention preferably connects to telephones primarily through an acoustic coupler, but can also communicate through any other suitable means such as a 2.5 mm (or other) headset jack, an RJ-11 connector, or the telephone's proprietary connector.

In one aspect, the communication interface device of the invention is a unique packaging together of a combination of components to provide a device with new and expanded opportunities for users of Computers and/or telephones. In the land telephone embodiment, the packaging together of a telephone acoustic coupler, a modem and a infrared transceiver (or any other method of communicating with Computers) provides unique and new applications of these components. The same applies in the mobile and/or wireless phone embodiment, which preferably includes some form of a telephone holder or support member. A preferred attribute of the holder or support member is to index the electrical connector of the telephone to the holder or support member and/or to hold the telephone antenna vertical and still. The vertical antenna and optimal orientation of the telephone within the holder or support member results in better reception and transfer of data within the system as well as between communication systems.

In another aspect, the communication interface device of the invention is also a system comprising the combination of: (1) a Computer-to-telephone interconnect device; (2) controlling software for many Computer operating systems; and, (3) Internet access subscription.

The invention provides the convenience and freedom to access the Internet from almost any telephone, almost anywhere in the world, almost without regard for the type of Computer and/or operating system used by such Computers.

One of the important advantages which the present invention has over existing products, services, methods and devices includes the ease of setup and use of many different telephones to access the Internet. With existing mechanisms available, a complex array of different hardware devices, software. Specific connections, and the like, are required, and the combination of the components may be different depending on the devices between which communication is to be established. The invention provides a universal type device which achieves these ends.

Thus, certain means of accomplishing the same goals require the purchase and complex assembly of an apparatus that is expensive (costs $200 to $400), and whose only purpose would be to send and receive email. Such systems would have no ability to process or send attachments, file transfers or faxes and browse the Internet. Yet other means of accomplishing the same goals require the separate subscription to an online service, usually with very limited geographic coverage areas, at very high prices.

### BRIEF DESCRIPTION OF THE DRAWINGS

FIG. 1 is a perspective view of one embodiment of the invention, without telephone attached;

FIG. 2 is an opposite perspective view of the embodiment of the invention in FIG. 1, with telephone attached;

FIGS. 3(a), 3(b) and 3(c) are cutaway top, front and side views respectively of the communications interface device of the invention, partially in section, showing certain internal components thereof;

FIG. 4 shows a schematic representation of one embodiment of the invention for use without a telephone;

FIG. 5 shows a schematic representation of another embodiment of the invention for use with a mobile or wireless telephone;

FIG. 6 shows a schematic representation of a Computer to land telephone interface device;

FIG. 7 shows a schematic representation of a Computer to cellular/PCS telephone interface device where the telephone is “Internet ready”;

FIG. 8 shows a schematic representation of a Computer to cellular/PCS telephone interface device which also works with most land phones, and

FIG. 9 is a perspective view of one embodiment of an interface device for use with a telephone.

### DETAILED DESCRIPTION OF THE INVENTION

In one embodiment of the communication interface device of the invention is a unique packaging together of several components comprising: (1) a Computer/PDA interface, such as an infrared transceiver, serial, USB, RJ-11 port, etc.; (2) a modem (optional); and, (3) a telephone interface, such as an acoustic coupler, 2.5 mm headset connector, a proprietary telephone connector, RJ-11 connector and the like.

The invention is, in one embodiment, a device to connect or interface Computers to telephone systems (wired or wireless) including a landline telephone without a normal RJ-11 telephone connector. The invention also preferably connects Computers to landline telephones and many mobile telephones without a hardwired telephone connection and/or a hardwired Computer connection. The invention achieves this by combining, preferably in one unit, an acoustic coupler (to the telephone) and an infrared transceiver (to the Compute) with an optional modem.

The invention, in one embodiment, connects Computers to mobile telephones with a telephone holder and an electrical interface. The invention preferably does this by combining in one unit a telephone holder and electrical interface (to the telephone) and an infrared transceiver (to the Computer) with an optional modem. The telephone holder holds the antenna still and vertical for better radio reception.

An advantage of the invention is that it presents an adaptable device that can be used with many different Computers and many different telephones.

In a sophisticated preferred embodiment of the invention, the communication interface device can connect to:

(a) land telephone lines through: (1) RJ-11 or other telephone hardwire connection; and/or, (2) an acoustic coupler.

(b) Cellular/PCS and other radio telephones through: (1) the telephone proprietary connector; (2) 2.5 mm. headset jack; and/or, (3) an acoustic coupler.

(c) Computers through: (1) infrared; (2) a Serial port; (3) an RJ-11 modem output; and/or, (4) a USB port.

It will thus be appreciated that the communication interface device of the invention relates, in one aspect, to the field of digital data transmission systems. More specifically, the invention comprises concepts, methods and devices for using any portable Computer to send and receive information over telephone lines using the Internet. One important advantage is to be able to use infrared, instead of cable, to connect the Computer to the telephone system through the devices in this patent, thus allowing the invention to communicate with many brands and models of Computers of many different operating systems.

It is advantageous to use the infrared port as a universal interface between Computers and telephones. It is also advantageous to use an acoustic coupler as a universal interface to telephones, packaged together with a Computer interface (with or without a modem). The modem can be in the device, outboard, between the Computer and the phone or built in to the Computer.

In one embodiment, the invention comprises:

1. Hardware: There are at least three different hardware devices. The device allows Computers to communicate with:

(a) Land phones where there is either no hardwired access, or connector difficulty, or technical difficulty, payphones, or digital multi-line systems. The hardware may be comprised of an acoustic coupler to connect a telephone with any or all of the following: modem, power supply, IR transceiver, RJ11 in/out port, USB port, serial in port. This device can also have an optional cellular telephone adaptor.

(b) Cellular phones of differing systems (AMPS, CDMA, TDMA, GSM, etc.) This hardware comprises a combination of a holder to hold a cellular phone with the antenna vertical with any or all of the following: modem, power supply, IR transceiver, RJ11 in/out, serial in/out, cellular/PCS phone's proprietary connector or a 2.5 mm headset plug. This device can also have an optional acoustic coupler for land phones and/or cellular phones.

A combination device may be provided with features of both of the above (a) and (b) devices.

2. Software: The software is used to connect the Computer to the Internet and control the sending/receiving of email, faxes and other files.

3. Internet Access: An Internet Service Provider.

The foregoing merely illustrates the general applications of the invention and it will thus be appreciated that those of ordinary skill in the art will be able to devise numerous alternative arrangements which, although not explicitly described herein, embody the principles of the invention and are within the spirit and scope thereof.

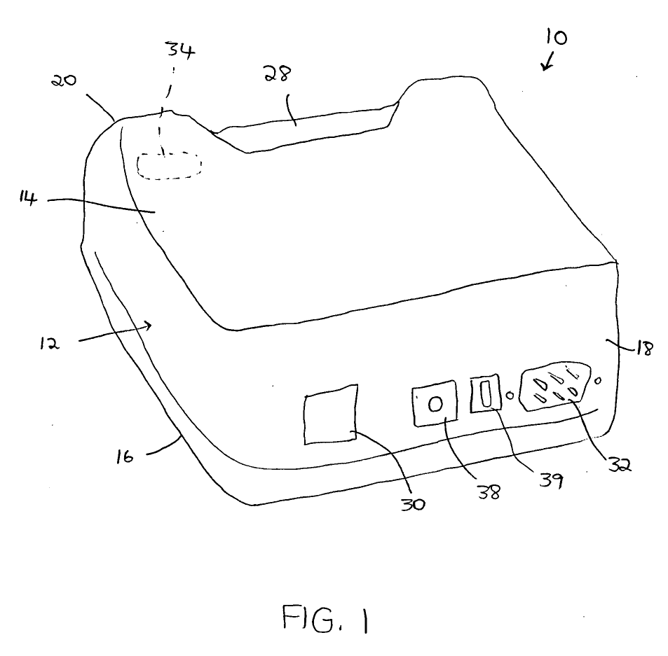

Reference is now made to FIG. 1 of the drawings which shows a perspective view of one embodiment of the interface device 10 invention. In FIG. 1, there is shown that the interface device 10 comprises a housing 12 having an upper surface 14, lower surface 16, rear wall 18 and front wall 20. The upper surface 14 and front wall 26 together define a recess or slot 28, which is adapted to connect to and receive a telephone as will be shown in subsequent Figures. The rear wall 18 of the housing 12 has various ports and devices for receiving and transmitting data. Thus, the rear wall includes an RJ-11 connection 30, a serial port 32, and a USB port 39. One or more of these ports is capable of attaching to a Computer in a predetermined and selected manner, and depending upon the nature of the connections available in such Computer.

It will be noted that the housing 12 has a fairly flat and wide lower surface which enables it to rest stably and effectively on a surface.

The interface device 10 is powered by one or more internal batteries, not shown in FIG. 1 of the drawings. However, the interface device 10 may also be powered by an external source, and is therefore provided with an appropriate AC input port 38 by means of which the appropriate electrical connection can be made.

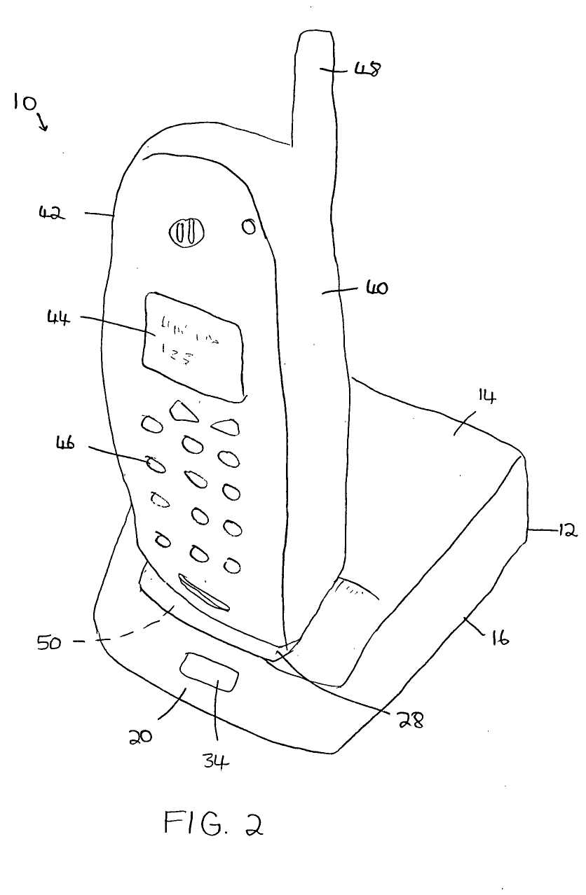

Reference is now made to FIG. 2 of the drawings, which shows the interface device 10 in perspective view from the front, and with a telephone 40 securely received within the recess 28. The telephone 40 shown in FIG. 2 of the drawings is a cellular or PCS wireless telephone, including a body portion 42, a display screen 44, operating keys 46 and an antenna 48. At the lower end of the telephone 40, but not visible in FIG. 2 of the drawings, the telephone 40 comprises connection means 50 by means of which the telephone can receive power, and through which transmission of data to and from the telephone 40 is effected. An infrared port 34 is also provided.

It will be noted that the telephone 40 is positioned within the recess 28 so that the telephone stands substantially in a vertical position. In this position, the antenna 48 has a location so as to provide optimal signal strength available in the circumstances.

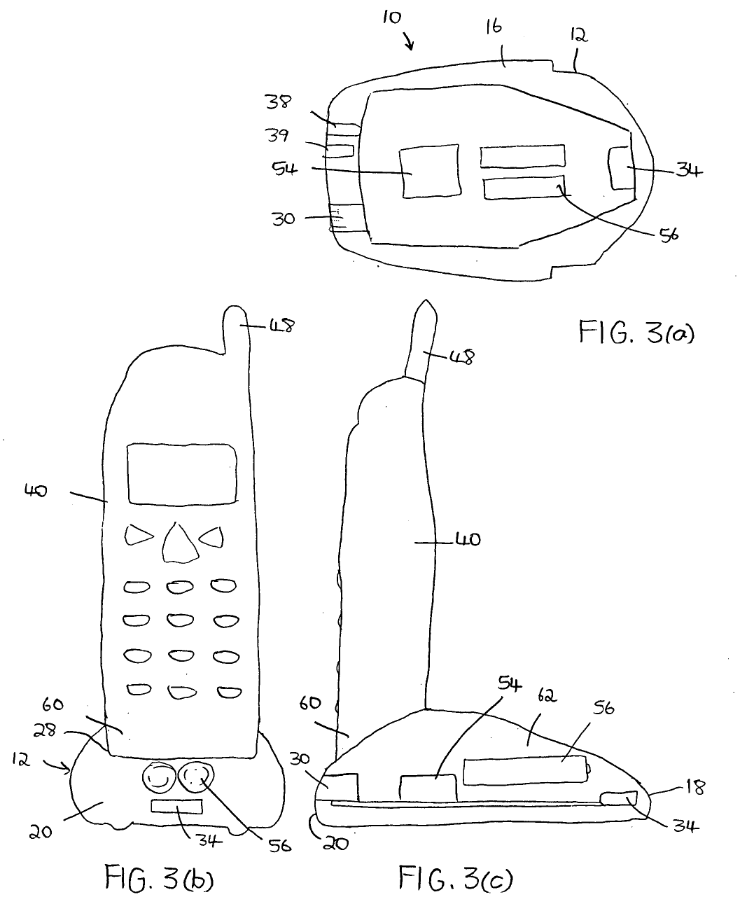

Reference is now made to FIG. 3(a) of the drawings which shows some of the internal components of the interface device 10 illustrated in FIGS. 1 and 2 of the drawings. FIG. 3(a) provides a top view of the interface device 10, FIG. 3(b) is a front view of the interface device 10, including telephone 40, while FIG. 3(c) is a side view of the interface device with telephone 40. With reference to FIG. 3(a), the housing 12 of the interface device accommodates a modem 54. The interface device 10 is powered by internally located batteries 56, of which there are two in the embodiment shown in FIG. 3(a), and accessible from the outside of the housing 12 so that these batteries 56 can be changed, as appropriate. The AC port 38 is shown, by means of which the interface device 10 can be connected to an outside source of power.

Data received by the modem 54, or transmitted from the modem 54, can be transmitted in various manners. First, the infra red port 34 provides for the transmission of data by a light beam, and requires, of course, that the receiving or transmitting Computer be so equipped so that the two devices can communicate using infra red light beams. Additionally, the interface device 10 includes a RJ-11 telephone jack, so that the interface device 10 can be connected through the RJ-11 connection port 30 by a cable extending from the interface device 10 to an appropriate RJ-11 on the Computer. The interface device 10 shown in FIG. 3(a) further comprises, but does not show, a serial port, having reference numeral 32 in FIG. 1 of the drawings, to connect the interface device 10 with an appropriate cable having a serial connecter to a Computer having the correct port.

FIG. 3(b) is a front view of the interface device 10 shown in FIG. 3(a). There is provided a housing 12, including the recess 28, which receives the lower end 60 of the telephone 40. FIG. 3(b) also shows the internal batteries 56 and the infra red port 34 located within the housing 12, and already described with respect to FIG. 3(a).

FIG. 3(c) shows a side view of the interface device 10 with telephone 40 seen in FIG. 3(b) of the drawings. The housing 12 of the interface device 10 can be clearly observed to define an internal chamber 62 which houses the various components, already described. The internal chamber 62 in FIG. 3(c) includes the RJ-11 port connection 30, a modem 54, an infra red port 34 and the internal batteries 56. Once more, the telephone 40 is shown in a substantially vertical position, designed so as to provide the best orientation for antenna 48, to thereby utilize optimal signal strength.

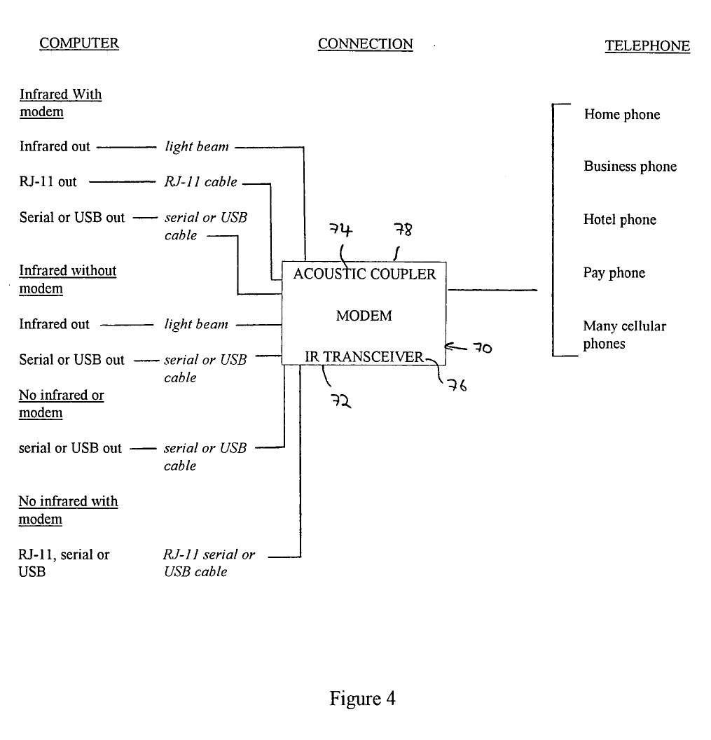

Reference is now made to FIG. 4 of the drawings, which shows diagrammatically the different forms of connection which can be established between a Computer and a telephone. The various connections which can be established, as shown in FIG. 4, apply mainly with respect to land-based telephones, but the situation illustrated in this Figure may also be suitable for many cellular phones.

In FIG. 4, the lefthand column shows the various types if Computer and Computer connections, while the right hand column describes various different types of phones and phone systems which can be used. The center column represents the connection between the Computer and the telephone, and essentially comprises an interface device of the type the same as, or similar to, that illustrated in FIGS. 1 to 3 of the drawings.

The connection used in FIG. 4 of the drawings comprises and interface device 70 including various components, notably a modem 72, an acoustic coupler 74 and a IR transceiver 76. The interface device 70, effecting the connection between the Computer and the telephone, is located within a housing 78, including various connector ports such as an infra red port, an RJ-11 jack port, USB port, and a serial port, as described above.

The various telephones that can be used and coupled to the interface device 70 through an appropriate connection comprise home phones, business phones, hotel phones, pay phones, as well as many types of cellular phones. All of these phones are connected to the interface device 70 so as to be in communication with the acoustic coupler 74 thereof, so that voice or other signals being transmitted to, or received from, the various phones listed, are converted by the acoustic coupler into electronic signals which can be processed by the modem 72.

In FIG. 4, four types of Computers are indicated, each having different characteristics. The first Computer is one having an infra red port with a modem, the second is a Computer having an infra red port without a modem, the third type of Computer is one having neither and infra red port nor the presence of a modem, and the fourth type is one having no infra red and a modem.

With reference to the Computer type wherein both an infra red port and a modem are provided, the Computer is able to connect to the interface device 70 by three possible mechanisms. First, the infra red port of the Computer communicates with a corresponding infra red port on the interface device 70 by means of a light beam. Thus, data is exchanged between the Computer and the interface device through the two infra red ports by transmission of light being therebetween, in a conventional manner as is well understood by those skilled in the art. Second, a connection may be established between the Computer having infra red with modem, and the interface device 70, by an RJ-11 cable. An RJ-11 cable, having the appropriate RJ-11 ports, runs between the interface device 70 and the Computer having the infra red with modem, and the transmission of signals is effected using this cable. Third, the connection may be established using the serial port(s).

The second type of Computer used is one where the Computer has an infra red port, but no modem, and the only option for communication between such a Computer and the interface device 70 of the invention would be by the transmission of light between appropriate infra red ports located on each of the Computers and the interface device 70 respectively.

The third arrangement is a Computer having neither an infra red port nor a modem. In this situation, the Computer and the interface device 70 would exchange data by transmission through a serial cable. The serial cable is of a conventional type, connecting at its one end to the interface device 70, and at its other end to the Computer or PDA.

The fourth arrangement has no infra red and a and exchanges data through an RJ-11, a serial cable or a USB port.

In one embodiment, a home phone, for example, is connected to the interface device, so that the phone receiver (including the speaker and microphone) is in proper communication with the acoustic coupler. Thus, voice or other signals in the speaker of the telephone will be processed by the acoustic coupler and electronically converted for use. The microphone is also appropriately connected for conversion of signals which can be received and processed by a Computer. With the home phone appropriately coupled to the interface device 70, the Computer is attached to the interface device either by an RJ-11 cable, a USB port or a serial port. If, however, both the Computer and the interface device 70 are to communicate using light beams between their respective infra red ports, no such physical connection is required.

With the setup between phone and Computer so established, with signals being transmitted through, and appropriately converted, by the interface device 70, the Computer is able to interface with the phone, and vice versa.

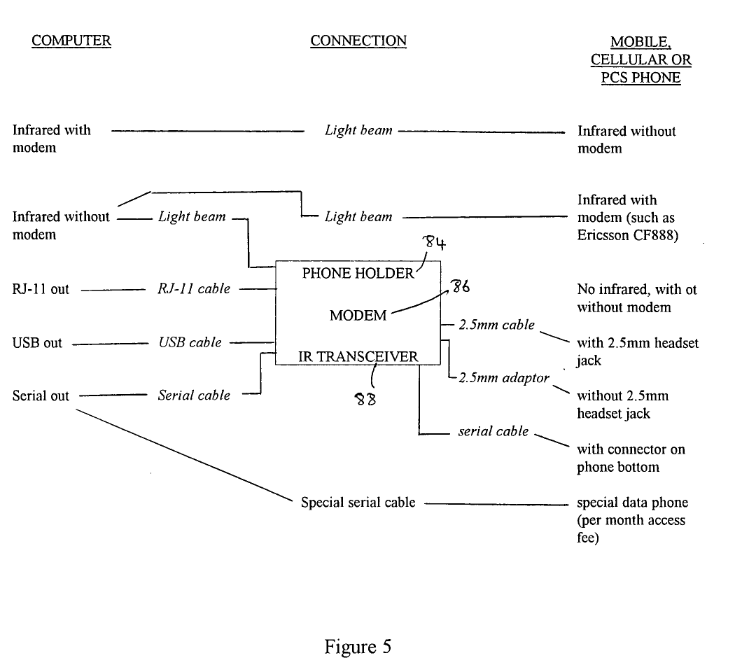

Reference is now made to FIG. 5 of the drawings, which shows a particular application of the invention suitable for use between a telephone and a mobile phone, including cellular or PCS phones. FIG. 5, like FIG. 4, comprises three columns, the lefthand column indicating the features and characteristics of a Computer which is being used, and the right hand column indicating the nature and characteristics fo the cellular or PCS phone. The center column indicates the type of connection established, in most part by virtue of the invention, between the Computer and the particular phone.

It will be noted that an interface device of the invention may not be needed in certain circumstances. Thus, where the Computer includes an infra red port for the transmission of data, and the cellular of PCS phone also includes an infra red port such that the transmission of data by means of a light beam between the Computer and cellular or PCS phone is capable of establishing the necessary line of communication, the interface device of the invention is not needed. Moreover, where special serial cables are provided, which often require the purchase of expensive cables, not to mention the need to obtain access to a phone system, which may include monthly charges, the interface device of the invention may not be required.

With reference to FIG. 5 of the drawings, there is shown an interface device 82 which comprises a housing containing a phone holder 84, a modem 86 and an infra red transceiver 88. The interface device 82 facilitates a connection between various forms and types of Computer, to be described, and various configurations of cellular, PCS or other wireless telephones.

The interface device 82 may be of a form, and have a physical appearance, substantially in accordance with the embodiment of the invention illustrated in FIGS. 1 to 3 of the drawings. Thus, the cellular, PCS or other wireless telephone would be located with respect to the phone holder, preferably within recess 28 as shown in FIG. 1 or 2 of the drawings, so that a telephone, having reference numeral 40 in the previous figures, stands in a stable and upright position, oriented to ensure an optimal signal strength of the telephone.

The various configurations of Computer mentioned in FIG. 5 of the drawings may be connected to the interface device 82, as illustrated. It will, of course, be appreciated that other configurations of Computer, different to those mentioned in FIG. 5, may exist which can be connected to the interface device 82. For example, the Computer may have no infra red but a modem, or it may have neither a modem nor an infra red port, but a USB port. These situations will be discussed briefly below.

In the first configuration of Computer, namely, infra red with modem, direct communication with a cellular or PCS phone is possible where such cellular or PCS phone is capable of transcribing light beams between its infra red port and an infra red port on the Computer device.

FIG. 5 further shows the configuration of a Computer having an infra red port without a modem. Such a configuration may allow communication directly with a cellular phone equipped with infra red and a modem. Only one such telephone is known to the Applicant at this time, the vast majority of telephones not including an infra red with modem. Therefore, a Computer configured so as to have an infra red without a modem would transmit and receive light beams with the interface device 82 by appropriate transmission of signals between the infra red ports of the interface device 82 and the Computer respectively.

It will also be seen that Computers having either or both of an RJ-11 port and/or a USB port and/or a serial port can be attached to the interface device 82 using an RJ-11 cable, a USB cable or a serial cable respectively.

Various forms of connecting the Computer to the interface device 82 have been described above, although not every configuration is, of course, mentioned. As a general principle, however, any Computer having any one of an infra red port, an RJ-11 jack, a USB port, or a serial port, whether with or without a modem can be appropriately connected to the interface device 82.

Where the cellular or PCS telephone has neither an infra red port, nor a modem, as is the case with many commonly used telephones, the telephone device can be coupled to the interface device so as to receive signals from the interface device, and transmit signals to it, in other manners. For example, a telephone provided with a 2.5 mm headset jack can be directly connected to the interface device 82 with a 2.5 mm cable. If the telephone does not possess such a 2.5 mm headset jack, a connection can nevertheless be established using a 2.5 mm adaptor. Where the telephone has a serial cable connector on the bottom of the phone, or at some other location thereof, a serial cable can be used to effect the appropriate connection between the telephone and the interface device 82.

Where the cellular or PCS phone has a modem, and no infra red device, the modem can be connected to the interface device 82 using the RJ-11 jack and cables, and/or the serial cable attached to serial port.

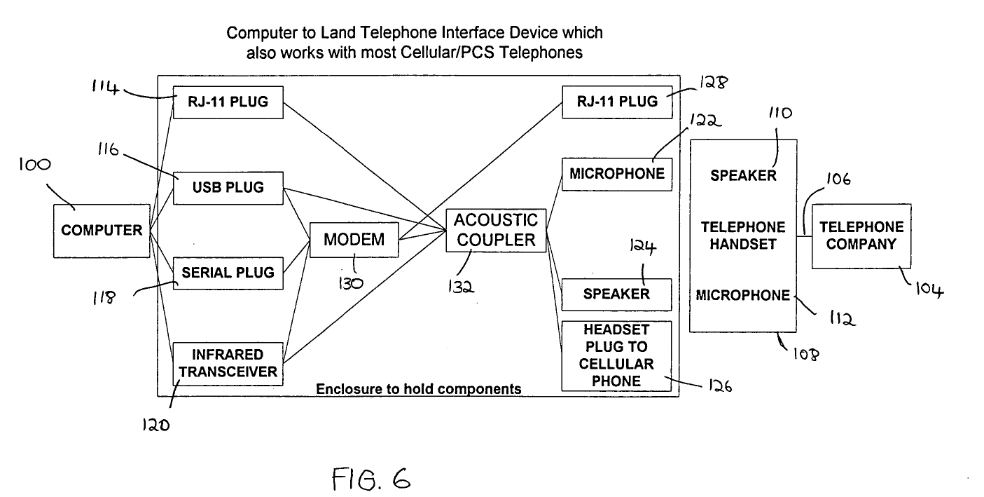

FIG. 6 shows a different representation of an interface device of the invention, diagrammatically illustrated to show some of the various combinations and modifications which may be present. In FIG. 6, there is shown an enclosure 96 for the interface device 98, the enclosure 96 in FIG. 6 being purely schematic, and shown in the form of a box containing the various components.

On one side of the enclosure 96, there is shown in representative format a Computer 100, which may be connected to the interface device 98 in various manners as will be described below. On the other side of the enclosure 96 there is shown a telephone handset 102, also connected to the interface device 98 in a manner to be described. The telephone handset 102 is, of course, part of a telephone, and is connected to telephone company switching equipment 104, schematically identified in FIG. 6. The connection 106 between the telephone handset 102 and the telephone company 104 is, for the most part, in this example, a hard wire, with the telephone having a landline. However, many cellular and PCS telephones will also have the ability to connect to the interface device 98 of the invention, as will be described.

The telephone handset 92 includes a housing 108, the housing 108 containing at one end a speaker 110, and at another end a microphone 112.

The interface device 98 comprises various ports and components whereby the Computer 100 may be connected thereto. Thus, the interface device 98 will include and RJ-plug 114, a USB plug 116, a serial plug 118, and an infra red transceiver 120. Depending upon the configuration of the Computer 100, and its components, it will be connected to the interface device 98 through one of these plugs, or by a light beam with the infra red transceiver 120. Where the Computer 100 has more than one appropriate outlet for the transmission and receipt of signals, the user will have the option of using the most convenient or effective connection so as to establish communication between the Computer 100 and the interface device 98.

Appropriate means to effect a suitable connection between the telephone handset 102 and the interface device 98 are also provided. Thus, the interface device 98 comprises a microphone 122 and a speaker 124, both configured within the enclosure 96 of the interface device 98 so that the microphone 122 is able to receive signals from the speaker 110 of the telephone handset 102, while the speaker 124 is able to transmit signals to the microphone 112 of the telephone handset 102. In this way, the interface device 98 is capable of receiving, processing or appropriately converting analog signals from the telephone handset.

The interface device 98 also contains within the enclosure 96 a headset plug 126, whereby the interface device 98 can be directly connected to the land phone or cellular phone. Thus, where the phone incorporates a headset plug, the appropriate hardware can be utilized to connect the telephone directly to the interface device 98 so that the signals, otherwise received from the speaker 110 and transmitted to the microphone 112, can be directly transmitted between the telephone handset 102 and the interface device 98 by a simple cable connection.

The interface device 98 further comprises an RJ-11 plug 128, so that the interface device 98 can be directly connected to the telephone company by an RJ-11 cable, if the appropriate RJ-11 plugs and jacks (or an adaptor) are present on the telephone.

The interface device 98 further includes within the enclosure 96 a modem 130 and an acoustic coupler 132.

Various pathways for communication signals between the Computer 100 and the telephone company 104 are provided for within the interface device 98. As shown in FIG. 6, the Computer 100 can be connected to any one of the RJ-11 plug 114, a USB plug 116, a serial plug 118, or communication may be established using a light beam through the infra red transceiver 120. When connected to the RJ plug 114, signals are processed by transmitting them from the RJ plug 114 to the acoustic coupler 132, and from the acoustic coupler 132 to either the headset plug 126, or to the microphone 122 and speaker 124. In both situations, all such signals from the microphone 122, speaker 124 or headset plug 126 are communicated to the telephone handset 102.

A Computer connection established through the USB plug 116 is similarly transferred either to the acoustic coupler 132, if the Computer has a modem, for onward transmission to the microphone 122, speaker 124 or headset 126, as described above with respect to the RJ-11 plug 114, or, if the Computer does not have a modem, the signal goes first to the modem 130.

Where the Computer is connected to the interface device 98 through the serial plug 118, the serial plug is in turn connected to the modem 130 for processing signals received from the serial plug 118. The modem 130 may then transfer the signals to the telephone company 104 in one of two ways. First, signals proceed from the modem 130 to the RJ-11 plug 128, the RJ-11 plug 128 being connectable to a telephone company 104 with an RJ-11 jack. Second, the modem 130 may transmit the signals to the acoustic coupler 132, for further transmission to the microphone 122, speaker 124 or headset 126, as has already been described.

Where a connection is established between the Computer 100 and the interface device 98 through the use of light beams traveling to and from the infra red transceiver 120, the infra red transceiver 120 can transmit the signal to either the modem 130, if the Computer has no modem, or the acoustic coupler 132 if the Computer has a modem. The modem 130 and acoustic coupler 132 transmit the signal to the microphone 122, speaker 124 or headset plug 126, as has already been described.

With the various combinations described above, it will be appreciated that the interface device 98 provides an effective connection between a Computer 100 and the telephone company 104 which otherwise would have been impossible to establish, or, if established, done only at considerable inconvenience with much hardware, and the possible payment of user fees. The interface device 98 therefore provides and efficient and simple mechanism by means of which the Computer 100 and telephone handset 102, or telephone company 104 connection can be easily accomplished.

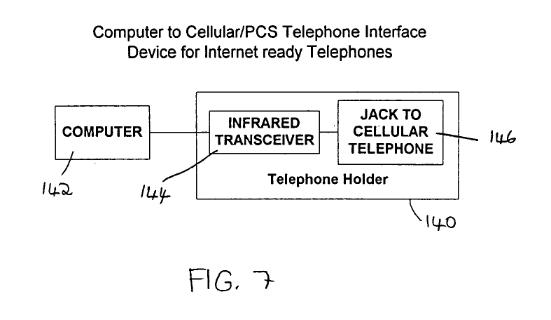

Reference is now made to FIG. 7 which shows, in diagrammatic format, an interface device for establishing communication between a Computer and a telephone, where the telephone is “Internet Ready”. An “Internet Ready” cellular telephone is capable of communicating data directly with the cellular telephone company.

In FIG. 7, there is shown a telephone holder 140 and a Computer 142. The telephone holder 140 and the Computer 142 communicate by the transmission of light beams between infra red transceiver 144 on the telephone holder 140, and a corresponding infra red transceiver (not shown) on the Computer 142. The infra red transceiver 144 is connected to a jack 146 which is connectable to a cellular telephone (not shown), thereby completing the connection between the telephone signals and the Computer 142.

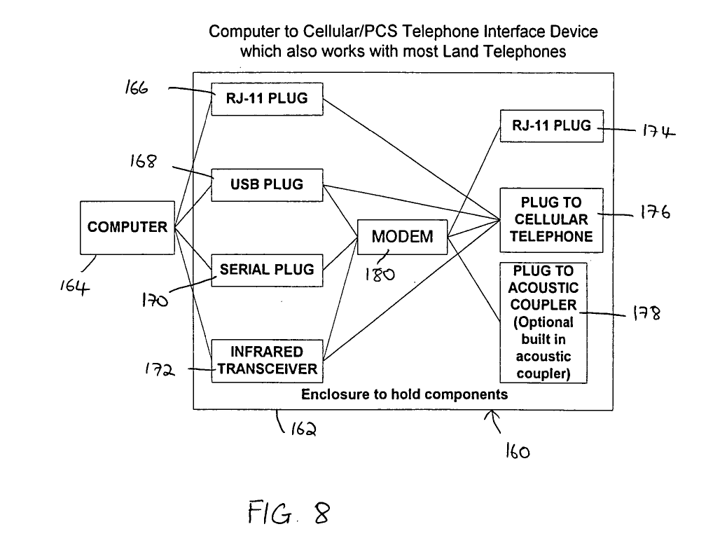

Reference is now made to FIG. 8 of the drawings. FIG. 8 is a schematic representation of communication between a Computer and cellular/PCS telephone interface device, which also works with most land based telephones. In FIG. 8, an interface device 160 is comprised of a housing 162 which contains a number of components. A Computer 164 is able to connect to the interface device 160 by any one of the following: an RJ-11 plug 166, a USB plug 168, a serial plug 170, or through the transmission of light beams between an infra red transceiver 172 in the interface device 160, and an infra red transceiver located on the Computer 164.

The interface device 160 also comprises various components for attachment to the cellular or PCS telephone. These include an RJ-11 plug 174, a plug 176 to the cellular telephone, and a plug 178 to an acoustic coupler. Optionally, the interface device 160 may comprise the acoustic coupler itself, along the same lines as those shown in FIG. 6 of the drawings, which shows an interface device including an acoustic coupler, microphone, speaker and headset plug.

Various pathways by means of which the Computer 164 can communicate with the telephone are shown in FIG. 8 of the drawings. These pathways are representative examples, and are not considered to be exhaustive. Other options within the interface device for transmitting signals between the Computer 164 and telephone (not shown) are within the scope of this invention.

Where the Computer 164 connects to the RJ-11 plug 166, the RJ-11 plug 166 may further transmit the signal to the plug 176 to the cellular telephone. In the situation where the Computer 164 is connected through a USB plug 168, the USB plug 168 may also transmit the signal to the plug 176 to the cellular telephone, or alternatively may send it to a modem 180. The modem 180 is then capable of transmitting the signal through any one of the RJ-11 plug 174, plug 176 to the cellular telephone, or plug 178 to the acoustic coupler, depending upon the type of connection made between the interface device 160 and the telephone.

Where the Computer 164 is connected through serial plug 170, the serial plug 170 communicates with the modem 180, and the modem 180, as described above, is capable of passing the signal on to the RJ-11 plug 174, plug 176 to the cellular telephone or the plug 178 to the acoustic coupler.

Finally, the Computer 164 and the interface device 160 may communicate by means of transmission of light beams between the infra red transceiver 172, and an infra red port on the Computer 164. The infra red transceiver 172 conveys the signal to the plug 176 to the cellular telephone, or to the modem 180. Where the signal is transmitted to the modem 180, further processing of the signal to one of the outlets already described may occur.

While the above description sets forth the various pathways by which signals from the Computer are sent to the telephone, it will be appreciated that signals sent from the telephone to the Computer will follow similar pathways, but with the signal being transmitted in the opposite direction.

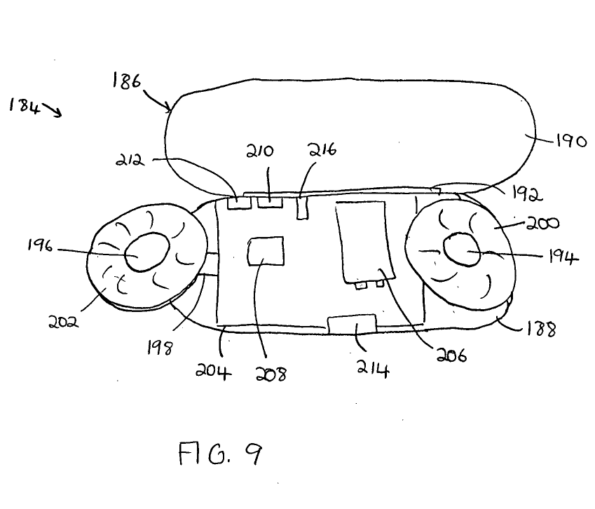

Reference is now made to FIG. 9 of the drawings, which shows a specific and preferred embodiment of an interface device 184 of the invention. As will be seen in FIG. 9, the interface device 184 is contained within a casing 186, the casing 186 having a base 188 and a lid 190 pivotally connected to the base 188 by means of a hinge 192. The lid 190 is therefore capable of pivotal movement about the hinge 192 so as to render the casing 186 in an open position, as shown in FIG. 9, and a closed position. The casing 186 is of a convenient size, such as that of a glasses case, so that it can be comfortably kept within the user's pocket for use when needed. Although not shown in FIG. 9 of the drawings, the casing may also contain somewhere on its external surface a clip or handle by means of which the casing 186 can be releasably secured to he user's clothing, such as on a belt or in a pocket.

Within the casing 186, and in the base 188 thereof, there is located at one end a speaker 194, and at the other end, a microphone 196. In the embodiment shown in FIG. 9, the speaker 194 is fixed within the casing 186, but the microphone 196 is mounted on a shaft 198, the shaft being slidable so that the position of the microphone 196 can be altered to vary the distance between the microphone 196 and the speaker 194. The characteristic whereby the distance between the speaker 194 and microphone 196 may be adjusted is important and useful, since these components are intended to receive and serve as an acoustic coupler for telephone handsets of varying size and dimension, and the ability to vary the distance insures that an optimal acoustic connection can be made between the interface device 184 and a telephone handset.

The speaker 194 is surrounded by an acoustic insolation pad 200, and the microphone 196 is surrounded by an acoustic isolation pad 202. The telephone handset rests on both of these pads 200 and 202 to reduce outside noise interference of transmitted signals between the telephone handset (which is not shown in FIG. 9) and the interface device 184.

Within the casing 186, there is located a component base 204 upon which the various components of the interface device 184 are mounted. Mounted on the component base 204 is a power supply 206 in the form of a battery, providing an independent and portable power supply for the interface device 184. Also mounted on the component base 104 is a modem 208, which is in contact with various connectors. These connectors include an RJ-11 connector 210, a USB connecter 212, and an infra red transceiver 214. All of these components are appropriately connected and interact with each other in a manner which has already been described with reference to some of the previous figures.

The interface device 184 also includes a power supply connector 216, whereby the interface device 184 can be optionally connected to an AC power source for use as a power supply, so that the battery power source 206 is only used when required, and the life of the battery thus conserved.

The interface device 184 is eminently portable, and can be taken by the user wherever necessary, without constituting any encumbrance. The lid 190 snaps into a closed position with respect to the base 188 so as to substantially seal the contents of the casing 186, to protect them from dust and damage. When needed, the interface device 184 can be easily setup by adjusting the position of the microphone 196 so as to create the appropriate distance from the microphone 196 to the speaker 194, and upon which the telephone handset is mounted. The interface device 184 is then connected to a Computer through one of the various ports provided therein or by establishing a light beam transmission using the infra red transceivers.

In summary, various embodiments and versions of the invention can be described as follows:

1. A method and device to hold a cellular/PCS/radio telephone antenna still and oriented vertically for better reception.

2. A method and device for integrating all components necessary for many different types of Computers to connect to many different types of telephones in one interface device.

3. A method and device for offering an integrated modem and telephone interconnect device bundled together with dial up Internet access and software for use with many different portable Computers of many different operating systems.

4. A method and device for using an infrared connection as a common interface to Computers of many different operating systems while using: an acoustic coupler as a common interface to telephones of many different types to transfer data both directions; a 2.5 mm headset jack as a common interface to telephone systems of many different types to transfer data both directions; an RJ-11 connection as a common interface to telephones of many different types to transfer data both directions; and the cellular/radio/PCS phones proprietary connector as a common interface to telephones of many different types to transfer data both directions.

5. A method and device for using a serial connection as a common interface to Computers of many different operating systems while using: an acoustic coupler as a common interface to telephones of many different types to transfer data both directions; a 2.5 mm headset jack as a common interface to telephones of many different types to transfer data both directions; an RJ-11 connection as a common interface to telephone systems of many different types to transfer data both directions; and the cellular/radio/PCS phones proprietary connector as a common interface to telephones of many different types to transfer data both directions.

6. A method and device for using a USB connection as a common interface to Computers of many different operating systems while using: an acoustic coupler as a common interface to telephones of many different types to transfer data both directions; a 2.5 mm headset jack as a common interface to telephones of many different types to transfer data both directions; an RJ-11 connection as a common interface to telephones of many different types to transfer data both directions; and the cellular/radio/PCS phones proprietary connector as a common interface to telephones of many different types to transfer data both directions.

7. A method and device for using a Compact Flash or PCMCIA connection as a common interface to Computers of many different operating systems while using: an acoustic coupler as a common interface to telephones of many different types to transfer data both directions; a 2.5 mm headset jack as a common interface to telephone systems of many different types to transfer data both directions; an RJ-11 connection as a common interface to telephones of many different types to transfer data both directions; and the cellular/radio/PCS phones proprietary connector as a common interface to telephones of many different types to transfer data both directions.

8. A method and device for using an RJ-11 connection as a common interface to Computer modems of many different operating systems while using: an acoustic coupler as a common interface to telephones of many different types to transfer data both directions; a 2.5 mm headset jack as a common interface to telephone systems of many different types to transfer data both directions; an RJ-11 connection as a common interface to telephones of many different types to transfer data both directions; and the cellular/radio/PCS phones proprietary connector as a common interface to telephones of many different types to transfer data both directions.

9. The method and device for using a device which connects between Computers (of many different operating systems) and telephones (of many different types), which device can also include a modem and/or power supply. The invention is unique in that it is able to couple to land phones by an acoustic coupler and to cell phones by either an acoustic coupler or through a direct wired connector.

1. A communications interface device for transferring signals between a selected discrete Computer and a selected discrete telephone, the interface device comprising:
a housing;
interface means accommodated by the housing for processing signals received from the selected discrete Computer and the selected discrete telephone;
first connecting means in or on the housing connectable selectively to the selected discrete Computer so that signals can be transmitted between the first connecting means and the selected discrete Computer, the first connecting means also being connected to the interface means; and
a second connecting means in or on the housing connectable selectively to the selected discrete telephone so that signals can be transmitted between the second connecting means and the selected discrete telephone, the second connecting means also being connected to the interface means,
the selected discrete computer being one of a plurality of discrete computers selectively connectable to the first connecting means and the selected discrete telephone being one of a plurality of discrete telephones selectively connectable to the second connecting means.

2. A communications interface device as claimed in claim 1 wherein the housing comprises a substantially enclosed box, the box having an externally provided recess for receiving a telephone.

3. A device as claimed in claim 2 wherein the recess is configured so that the telephone is oriented in a substantially vertical position so that the antenna thereof is positioned for optimal signal strength.

4. A communications interface device as claimed in claim 1 wherein the first connecting means is selected from one or more of an RJ-11 plug, a serial port, a USB port and an infra red transceiver.

5. A communications interface device as claimed in claim 1 wherein the first connecting means is a serial port.

6. A communications interface device as claimed in claim 1 wherein the first connecting means is a USB port.

7. A communications interface device as claimed in claim 1 wherein the first connecting means comprises an infra red transceiver.

8. A communications interface device as claimed in claim 1 wherein the telephone is a land telephone which transmits signals through cables.

9. A communications interface device as claimed in claim 1 wherein the telephone is a wireless telephone.

10. A communications interface device as claimed in claim 9 wherein the wireless telephone is one selected from the group consisting of a cellular and PCS telephone.

11. A communications interface device as claimed in claim 1 wherein the interface means is selected from one or more of a modem and an acoustic coupler.

12. A communications interface device as claimed in claim 1 wherein the processing means comprises an acoustic coupler.

13. A communications interface device as claimed in claim 1 wherein the processing means comprises a modem and an acoustic coupler.

14. A communications interface device as claimed in claim 11 further comprising a microphone and speaker forming part of the acoustic coupler.

15. A communications interface device as claimed in claim 11 further comprising a headset plug for connection to a cellular phone, the headset plug forming the communications interface.

16. A communications interface device as claimed in claim 1 wherein the second connecting means is selected from one or more of an RJ-11 port, a serial cable-port connector, and a 2.5 mm cable.

17. A communications interface device as claimed in claim 1 wherein the second connecting means comprises a serial cable-port connector.

18. A communications interface device as claimed in claim 1 wherein the second connecting means comprises a 2.5 mm cable.

19. A communications interface device as claimed in claim 1 further comprising a power source.

20. A device as claimed in claim 19 wherein the power source is a battery.

21. A device as claimed in claim 19 wherein the power source is external power and the device comprises an AC connecter to receive such power.

22. A communications interface device as claimed in claim 1 wherein the first connecting means is a compact flash or PCMCIA connection.

23. A communications interface device as claimed in claim 1 wherein the second connecting means is a compact flash of PCMCIA connection.

24. A communications interface device as claimed in claim 1 further comprising a dial-up Internet access and software for use with a plurality of Computers having a plurality of operating systems.

25. A communications interface device comprising:
a casing comprising a base portion and a lid hinged thereto, the lid being movable between an open and closed position with respect to the base portion, the casing defining a chamber;
a microphone located within the chamber;
a speaker located within the chamber;
means for varying the distance between the microphone and the speaker;
a power source;
at least one connection port to facilitate communication between the interface device and a selected discrete Computer; and
a modem connected to the microphone and/or speaker as well as the connection port.

26. A communications interface device as claimed in claim 25 further comprising acoustic insolation members on the speaker and microphone.

27. A device as claimed in claim 25 wherein the power source comprises a battery located within the housing.

28. A device as claimed in claim 25 wherein the power source is external to the interface device, and the interface device further comprises an AC connector for receiving such power.

29. A device as claimed in claim 25 wherein the connection port is selected from one or more of an infra red transceiver, a USB connector, and an RJ-11 connector.

30. A device as claimed in claim 25 wherein the connection port comprises a USB connector.

31. A device as claimed in claim 25 wherein the connection port comprises an RJ-11 connector.

32. A device as claimed in claim 25 further comprising attachment means on the exterior of the casing to facilitate attachment of the interface device.

33. A communications interface comprising:
interface means for processing signals between a selected discrete Computer and a selected discrete telephone;
first connecting means connectable selectively to the selected discrete Computer and the interface means; and
a second connecting means connectable selectively to the telephone and the interface means,
the selected discrete computer being one of a plurality of discrete computers selectively connectable to the first connecting means and the selected discrete telephone being one of a plurality of discrete telephones selectively connectable to the second connecting means.

34. A method for transferring signals between a selected discrete Computer and a selected discrete telephone, the method comprising:
providing interface means for processing signals received from the selected discrete Computer and the selected discrete telephone;
connecting first connecting means to the interface means, the first connecting means being connectable selectively to the selected discrete Computer so that signals can be transmitted between the first connecting means and the selected discrete Computer; and
connecting second connecting means to the interface means, the second connecting means being connectable to the selected discrete telephone so that signals can be transmitted between the second connecting means and the selected discrete telephone.
